(19) United States
(12) Patent Application Publication
(10) Pub. No.: US 2009/0043657 A1
(43) Pub. Date: Feb. 12, 2009

(54) SYSTEM AND METHODS FOR SELECTING ADVERTISEMENTS BASED ON CALLER IDENTIFIER INFORMATION

(75) Inventors: Roderick Swift, Walnut Creek, CA (US); Manjirnath Chatterjee, San Francisco, CA (US); Gregory R. Simon, San Francisco, CA (US)

Correspondence Address: KACVINSKY LLC;4500 BROOKTREE ROAD, SUITE 102, WEXFORD, PA, 15090, US

(73) Assignee: PALM, INC., Sunnyvale, CA (US)

(21) Appl. No.: 12/186,303

(22) Filed: Aug. 5, 2008

Related U.S. Application Data
(60) Provisional application No. 60/954,022, filed on Aug. 6, 2007.

(51) Int. Cl. G06Q 30/00

(52) U.S. Cl. 705/14

(57) ABSTRACT

Various embodiments are directed to selecting a web advertisement based on caller identifier information. The caller identifier information may be obtained from an incoming call to the mobile device or from an outgoing call from the mobile device. An ad request may be generated based on the caller identifier information by the mobile device and sent to a web advertising server. In response to the ad request, the web advertising server may select a relevant web advertisement based on the caller identifier information and may send the relevant web advertisement to the mobile device. On the mobile device, the web advertisement may be inserted into a web application for display in a user interface.

### RELATED APPLICATIONS

This application claims priority to U.S. Provisional Patent Application Ser. No. 60/954,022, which was filed on Aug. 6, 2007. This application is also related and claims priority to U.S. patent application Ser. No. 11/382,058 titled “Method for Synchronizing Software Application and User Data for Asynchronous Client-Server and Peer to Peer Computer Networks,” which was filed on May 8, 2006; U.S. patent application Ser. No. 11/612,282 titled “System for Running Web Applications Offline and Providing Access to Native Services,” which was filed on Dec. 18, 2006; U.S. patent application Ser. No. 11/873,305 titled “Offline Automated Proxy Cache for Web Applications,” which was filed on Oct. 16, 2007; U.S. patent application Ser. No. 12/019,362 titled “System and Methods for Providing Granular Security for Locally Running Scripted Environments and Web Applications,” which was filed on Jan. 4, 2008; U.S. patent application Ser. No. 12/061,179 titled “System and Methods for Providing Access to a Desktop and Applications of a Mobile Device,” which was filed on Apr. 2, 2008; U.S. patent application Ser. No. 12/116,697 titled “Automatic Conversion Schema for Cached Web Requests,” which was filed on May 7, 2008; and U.S. patent application Ser. No. 12/181,776 titled “Application Management Framework for Web Applications,” which was filed on Jul. 29, 2008. These applications are entirely incorporated by reference.

### BACKGROUND

Web browsers have become highly capable software packages in recent years. In addition to rendering web pages, many web browsers also support the ability to run more complex web applications in the web browser. Such web applications may be implemented using various web technologies such as HTML, XHTML, XML, and Asynchronous JavaScript and XML(Ajax).

Although a web application has many advantages, it suffers in a number of areas. For instance, because the web application depends on the web browser, the web browser must start before the web application can run. This delay may be unappealing to the end user, especially if the device running the web application has limited processing capability, as is the case for many mobile devices. In addition, if the web browser is not running, the web application is not running either. Therefore, the web application is unable to update its data. Furthermore, if the user wishes to run several web applications at the same time, the user must explicitly start each application. Also, there is no simple way for multiple web applications to have a shared set of user input controls.

Web-based advertising has become common practice, whereby advertisements are inserted into web pages based on a variety of criteria. While some web-based advertising systems display advertisements relevant to a user's query on an Internet-enabled mobile device, these systems deliver advertising content only when the mobile device is online. If the web browser of the mobile device is not connected to the Internet, however, the advertisement cannot be inserted into the web page. For a mobile device, such as a cellular telephone, it is common for the device to be disconnected from the network when receiving a when weak signal or when out of a coverage area. Furthermore, the advertisement hosting provider cannot collect advertising revenue for ads that are clicked when the device is offline, even though the end user has viewed and/or clicked the ad. In such cases, an advertiser may get the benefit of the advertising without paying the provider for use of the communication medium.

### BRIEF DESCRIPTION OF THE DRAWINGS

FIG. 1 illustrates an embodiment of mobile device displaying a web application user interface including a web advertisement.

FIG. 2 illustrates an embodiment of communications system including a computing device and a web advertising server.

FIG. 3 illustrates an embodiment of a logic flow for storing caller identifier information.

FIG. 4 illustrates an embodiment of a logic flow for storing a web advertisement.

FIG. 5 illustrates an embodiment of a logic flow for inserting a web advertisement into a web application.

FIG. 6 illustrates an embodiment of a logic flow for inserting a web advertisement into a web application.

FIG. 7 illustrates an embodiment of a mobile device displaying a telephone application user interface including a web advertisement.

### DETAILED DESCRIPTION

Various embodiments are directed to a system and methods for selecting a web advertisement based on caller identifier information. The caller identifier information may comprise, for example, caller identification (caller ID) data, a telephone number, and/or any other suitable identifier associated with an identity of one or more calling parties or called parties. The caller identifier information may be obtained from an incoming call to the mobile device or from an outgoing call from the mobile device. An ad request may be generated based on the caller identifier information by the mobile device and sent to a web advertising server. The ad request may be sent to the web advertising server immediately or deferred until at a later time. The ad request may be used for querying the web advertising server with the caller identifier information.

In response to the ad request, the web advertising server may select a relevant web advertisement based on the caller identifier information and may send the relevant web advertisement to the mobile device. The mobile device may receive the web advertisement relevant to the caller identifier information from the web advertising server and store the web advertisement in a local database on the mobile device.

On the mobile device, the web advertisement may be inserted into a web application. The web advertisement may be displayed in the telephone user interface software or in a separate software application. The web advertisement may be displayed immediately in a user interface on the mobile device such as in a telephone user interface during a call. The web advertisement also may be stored and displayed at a later time.

When the user views and/or clicks on the web advertisement, the mobile device logs the interaction (e.g., view and/or click) of the user with the web advertisement. User/ad interaction may be submitted to web advertising server immediately (online mode) or deferred (offline mode). In some implementations, the user may receive credit for interacting with web advertisements. For example, a business method may be implemented in which revenue from the advertiser may be used to partially or wholly subsidize the user's ownership or service plan for the mobile device.

In various implementations, the described embodiments enable advertisers to acquire valuable information about relationships between buyers and sellers. In addition, such information may be collected in an efficient and inexpensive manner. The described embodiments allow advertisers to quickly gain insight into specific types of buyer-seller relationships and generate precision-targeted advertisements based on the specifics of an individual user. For example, an advertiser may target a user based on the identification of a probable existing relationship between a customer and a seller or service provider. The advertiser also may make a special offer available to an existing customer or may make a special offer from a competitor to a potential customer.

The caller identifier information of an incoming call or of an outgoing call may provide a useful context to query for additional related information. For example, the user may benefit from knowing if there are recent news articles about a vendor that he or she is calling. In some implementations, when a friend calls, the user may benefit by being reminded of the caller's birthday, anniversary, etc. This information may generate a query to an advertising server which may then result in an offer to the user being displayed in a web application user interface on the mobile device. In these cases, the user of the mobile device benefits from the additional context-sensitive information, and an advertiser benefits from reaching a potential customer who has a significant likelihood of being interested in targeted offers from an advertiser.

The described embodiments also provide an additional advantage in that information may be obtained from caller identifier tags (e.g., caller ID tags) or subsequent queries. The information obtained from the caller identifier tags or subsequent queries need not be used immediately. Instead, this information may be stored or cached for later use at an appropriate time, even when the mobile device 100 is not immediately connected to a network or out of cellular coverage, such as in an airplane or in a tunnel.

A further advantage of the described embodiments is that the information obtained from the caller identifier tags or subsequent queries may be used directly in a web application on the mobile device. This is advantageous to the user because the interaction model with a web application (e.g., inputs using a stylus, keypad, mouse, etc., clicking hyperlinks, scrolling pages, and so forth) is familiar to the user. Additionally, web publishers are familiar with web application programming and thus need no special programming skills specific to the mobile device of the user. Moreover, the web application provides a simple mechanism to link further information or web resources directly to the caller identifier information without having to switch applications or wait for a special software application to start up (“boot”).

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

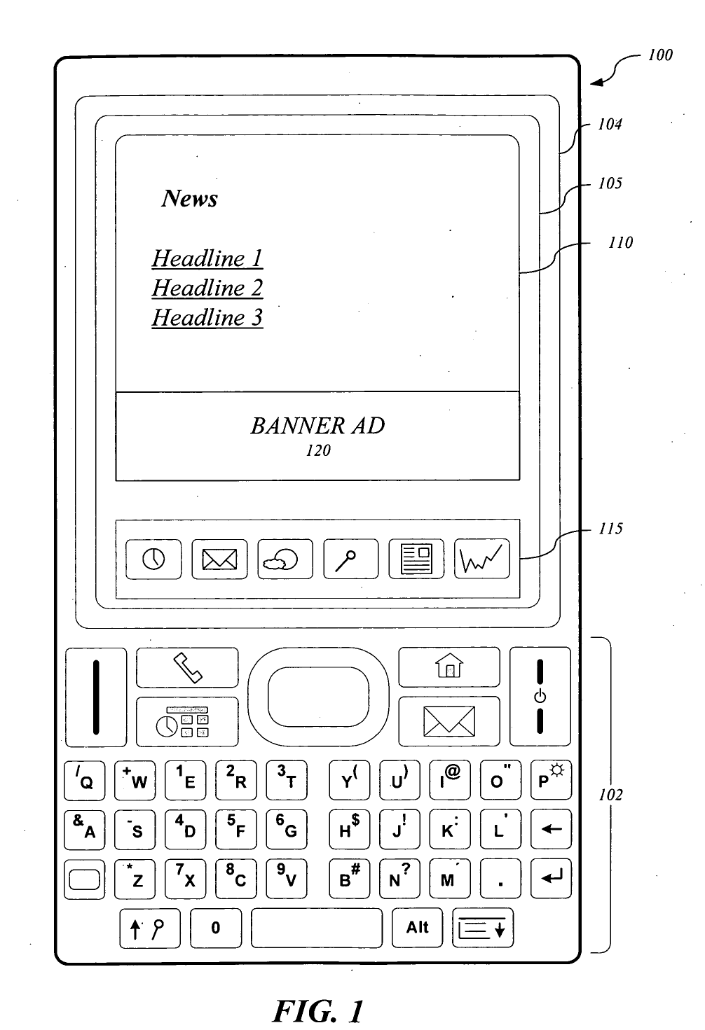

FIG. 1 illustrates a mobile device 100 suitable for implementing various embodiments. As shown, the mobile device 100 may be implemented as a combination handheld computer and mobile telephone, sometimes referred to as a smart phone. It can be appreciated that the mobile device 100 may comprise a computing device having a handheld form factor. While certain exemplary embodiments may be described with the mobile device 100 implemented as a smart phone by way of example, the mobile device 100 may be implemented as other types of computing devices such as a mobile telephone, a software telephone phone running on a computer, or other suitable computing device having computing and communications capabilities in accordance with the described embodiments. Exemplary computing devices may include a personal computer (PC), desktop PC, notebook PC, laptop computer, smart phone, mobile telephone, personal digital assistant (PDA), combination mobile telephone/PDA, mobile computing device, user equipment (UE), mobile unit, subscriber station, video device, television (TV) device, digital TV (DTV) device, high-definition TV (HDTV) device, media player device, gaming device, messaging device, pager, or any other suitable communications device in accordance with the described embodiments.

In various embodiments, elements of the mobile device 100 or other computing device may comprise physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints.

The mobile device 100 generally may be configured to support or provide cellular voice communication, wireless data communication, and computing capabilities in accordance with the described embodiments. The mobile device 100 may comprise various components for providing such capabilities including, for example, a printed circuit board (PCB), one or more processors (e.g., host processor, radio processor), one or more transceivers (e.g., voice communications transceiver, data communications transceiver, GPS transceiver), memory (e.g., volatile or non-volatile memory, removable or non-removable memory, erasable or non-erasable memory, writeable or re-writeable memory), internal and/or external antennas, a rechargeable battery, and others.

In various implementations, the mobile device 100 may form part of a wired communications system, a wireless communications system, or a combination of both. For example, the mobile device 100 may be arranged to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile device 100 may be arranged to communicate information over one or more types of wireless communication links such as a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. Although certain exemplary embodiments may be described as using a particular communication media by way of example, it may be appreciated that the principles and techniques discussed herein may be implemented using various communication media and accompanying technology.

The mobile device 100 may provide voice and wireless data communications functionality by communicating with a mobile network such as a Code Division Multiple Access (CDMA) network, Global System for Mobile Communications (GSM) network, North American Digital Cellular (NADC) network, Time Division Multiple Access (TDMA) network, Extended-TDMA (E-TDMA) network, Narrowband Advanced Mobile Phone Service (NAMPS) network, third generation (3G) network such as a Wide-band CDMA (WCDMA) network, CDMA-2000 network, Universal Mobile Telephone System (UMTS) network, and others.

The mobile device 100 also may support wireless wide area network (WWAN) data communications services including Internet access. Examples of WWAN data communications services may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile device 100 may provide wireless local area network (WLAN) data communications functionality in accordance with the Institute of Electrical and Electronics Engineers (IEEE) 802.xx series of protocols, such as the IEEE 802.11 a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile device 100 also may be arranged to perform data communications functionality in accordance with shorter range wireless networks, such as a wireless personal area network (PAN) offering Bluetooth® data communications services in accordance with the Bluetooth® Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

The mobile device 100 may comprise various input/output (I/O) interfaces for establishing connections to other devices. The I/O interfaces may comprise, for example, a serial connection port, an IR port, a Bluetooth® interface, a network interface, a WiFi interface, a WiMax interface, a cellular network interface, a wireless network interface card (WNIC), a transmitter, a receiver, a transceiver, and so forth. In wireless implementations, the I/O interfaces may comprise components such as one or more amplifiers, filters, control logic, antennas, and so forth.

In some implementations, a connection may comprise a wired connection such as a Universal Serial Bus (USB) connection (e.g., USB host, USB net), Serial Bus Interface (SBI) connection (e.g., FireWire®), or other suitable wired connection to directly connect (e.g., tether, plug in) the mobile device 100 to a device when in close proximity. In other implementations, a connection may comprise a short range wireless connection (e.g., Bluetooth® connection, IR connection) to communicatively couple the mobile device 100 to a device when in close proximity. In some implementations, the a connection may comprise a network connection between the mobile device 100 and a device such as a WiFi connection, WiMax connection, Ethernet connection, cellular network (e.g., 1G/2G/3G) connection, or other suitable packet data or switched connection in accordance with the described embodiments.

The mobile device 100 may comprise various software programs such as system programs and applications to provide computing capabilities in accordance with the described embodiments. Exemplary system programs may include, without limitation, an operating system (OS), device drivers, programming tools, utility programs, software libraries, application programming interfaces (APIs), and so forth. Exemplary operating systems may include, for example, a Palm OS®, Microsoft® OS, Unix® OS, Linux® OS, Symbian OS™, Embedix OS, Binary Run-time Environment for Wireless (BREW) OS, JavaOS, a Wireless Application Protocol (WAP) OS, and others.

The mobile device 100 may provide a variety of applications for allowing a user to accomplish one or more specific tasks. Exemplary applications may include, without limitation, a web browser application, telephone application (e.g., cellular, VoIP, PTT, voicemail), networking application, messaging application (e.g., e-mail, IM, SMS, MMS, chat, video teleconferencing, facsimile), contacts application, calendar application, word processing application, spreadsheet application, database application, media application (e.g., video player, audio player, multimedia player, digital camera, video camera, media management), location based services (LBS) application, gaming application, and so forth. Messaging applications may be arranged to communicate various types of messages in a variety of formats. Each messaging application may be representative of a particular kind of transport, enabling handling of messages of particular types and formats for the particular application. It is to be understood that the embodiments are not limited in this regard and that the mobile device 100 may include other applications in accordance with the described embodiments. The applications may comprise or be implemented as executable computer program instructions stored on computer-readable storage media such as volatile or non-volatile memory capable of being retrieved and executed by a processor to provide operations for the mobile device 100.

The memory also may implement various databases and/or other types of data structures (e.g., arrays, files, tables, records) for storing data for use by the processor and/or other elements of the mobile device 100. The mobile device 100 may comprise, for example, a message content database arranged to store content and attachments (e.g., media objects) for various types of messages sent and received by one or more messaging applications. The mobile device 100 may comprise a message log arranged to track various types of messages which are sent and received by one or more messaging applications. Entries in the message log may reflect recently made and/or attempted communications. In some implementations, the entries in the message log may be accessed by the user for replying to a missed message and/or for reinitiating or reattempting communication with a particular individual.

The mobile device 100 may comprise a contacts database arranged to store contact records for individuals or entities specified by the user of the mobile device 100. The contact record for an individual may comprise identifying information such as first name, last name, company/employer name, mailing addresses (e.g., home, work, other), telephone numbers (e.g., home, work, mobile, fax, pager), e-mail address (e.g., home, work, primary, alternate), IM screen names, SMS identifier, MMS identifier, personal information, notes, and so forth. The contacts database may be used or accessed when receiving and/or sending various types of messages. In some cases, identifying information (e.g., telephone number, e-mail address, IM screen name, SMS identifier, MMS identifier, etc.), included in messages received by messaging applications may be compared against the contacts database to identify the sender of a message. The contacts database also may be used or accessed when composing and/or sending messages. For example, the user of the mobile device 100 may search for and open the contact record of a particular individual to initiate communication. In addition, contact records in the contacts database may be filtered and matched against text typed by a user in one or more messaging applications to facilitate message addressing.

The mobile device 100 may comprise a preferences database arranged to store various settings such as rules and parameters for controlling the operation of the mobile device 100. In some embodiments, the preferences database may store privacy rules and security parameters for controlling communications options for messaging applications provided by the mobile device 100.

The mobile device 100 may comprise a media database arranged to store various types of media content such as image information, audio information, video information, A/V information, and/or other data. In some embodiments, the media database may be arranged to store various types of compressed or uncompressed content or information. The content or information may include command information, control information, routing information, processing information, system file information, system library information, software (e.g., OS software, file system software, application software, game software), firmware, an application programming interface (API), a program, an applet, a subroutine, an instruction set, an instruction, computing code, logic, words, values, symbols, and so forth.

The mobile device 100 may comprise various components or devices for interacting with an application such as keypad 102 for inputting data and/or commands and a display 104 (e.g., touch-sensitive screen) for presenting one or more user interfaces and receiving user input. It can be appreciated that the mobile device 100 may comprise a variety of components or devices for use with one or more applications such as a stylus, keys (e.g., input keys, preset and programmable hot keys), buttons (e.g., action buttons, a multidirectional navigation button, preset and programmable shortcut buttons), a jog-dial wheel, switches, a microphone, speakers, an audio headset, a camera, and so forth.

In accordance with various embodiments, the mobile device 100 may present a web browser user interface (UT) 105 an instance of a web browser which may be implemented by a desktop and/or mobile version of a web browser such as Internet Explorer®, Mozilla®, Firefox®, Safari®, Opera®, Netscape Navigator®, and/or any other suitable web browser in accordance with the described embodiments. The web browser may support various computer programming languages, standards, web protocols, and/or technologies required to implement the described embodiments. Exemplary computer programming languages, standards, web protocols, and/or technologies which may be used by one or more embodiments may include, but are not limited to, HTML, XHTML, XML, WML, VMRL, Flash®/ActionScript, Macromedia® Flash®, JavaScript, ECMAScript, JScript, Basic, Visual Basic®, Visual Basic® Scripting Edition(VBScript), CSS, CSS2, Asynchronous JavaScript and XML(Ajax), Flex®, Java®, Python, Perl®, C#/.net, Flash®, and/or other suitable programming, scripting, or Virtual Machine (VM)-based languages. In addition, the web browser may support “local” surfing, where “localhost” resources may be accessed with no requirement for connectivity to a network. It can be appreciated that some present day web browsers may attempt to connect to a network even when only localhost resources are needed, which may interfere with the operation of some embodiments.

In various implementations, the web browser may provide the basis of the user interface and may include a language interpreter such as a script interpreter for computer programming languages such as JavaScript®, Flash®, VBScript, and/or other scripted programming languages where browser-based scripts, bytecode sets, or languages are interpreted in real time by runtime interpreter. The web browser may provide a platform for running web applications in the web browser using various web technologies such as HTML, XHTML, XML, Asynchronous JavaScript and XML (Ajax), and so forth.

As shown, the web browser UT 105 may display a web application UT 110 corresponding to a web application. In this exemplary embodiment, the web application may comprise a news reader application or widget, and the web application UT 110 may display headlines for one or more news items. In various implementations, the headlines may comprise hyperlinks to the full versions of the news items.

In various embodiments, the web browser may implement an application management framework as described in U.S. patent application Ser. No. 12/181,776 titled “Application Management Framework for Web Applications,” which was filed on Jul. 29, 2008 and is entirely incorporated by reference. The application management framework may run within the web browser and may be written in any computer programming language supported by the web browser such as in one or more programming, scripting, or VM-based languages. For example, various standard web technologies such as HTML, CSS, JavaScript, ECMAScript may be applied to create the application management framework.

The application management framework may comprise and encapsulate multiple web applications which may be written in any language supported by the web browser. The source code for the web applications and for the application management framework may be highly portable across a wide array of hardware and software platforms such as desktop computers, mobile phones, and so forth. Additionally, a central server can pre-load the set of web applications into the application management framework and serve the entire application management framework to many computing devices. In some embodiments, the web applications may be implemented within the application management framework as one or more mini applications or widgets.

The application management framework may control aspects of the one or more of the contained web applications. For example, the application management framework may control which web applications is visible to the user at a given time, whether a web application is actively processing data, and/or when to direct a web application to be “refreshed” or reloaded into the web browser. The application management framework also may prompt one or more of the contained web applications to reload or update its data.

In various implementations, the application management framework may provide a mechanism for developers to incorporate multitasking into one or more of the web applications. For example, by programmatically “hiding” a web application using a hidden frame, the application management framework may allow a web application to run in the background while the user sees the user interface of a different web application.

The application management framework may allow a user to switch between and among the web applications quickly without having to re-launch the web browser or HTML application environment. In various implementations, for example, a plurality of web applications may run simultaneously within the application management framework. In one embodiment, the web applications may run in an HTML “iframe” within the application management framework. When multiple web applications are already running and resident in memory, switching between and among the web applications generally requires very little time, thereby improving the user experience. Sharing the web browser application management framework provides the capability for rapidly switching between applications, allows for multitasking, facilitates using a common set of input controls for applications, and makes it possible for applications to be available with little perceived startup (“boot”) time.

The web browser and/or the application management framework may capture user interaction events, such as mouse clicks, stylus clicks, keyboard input, jog wheel input, touchscreen input, voice input, button input, and so forth. One or more captured events may be selectively passed to one or more of the web applications contained in the application management framework. This facilitates creation of a group of web applications that together have a common set of user input controls. Additionally, it simplifies web application development for devices with limited input controls. For example, on a mobile telephone it is advantageous to permit control of a web application with one finger. In various embodiments, the application management framework may support the ability of a user to switch between and among the web applications through quickly using a single finger or “mouseover” action providing for a pleasant user experience. The application management framework may provide a user interface for rapidly switching between the web applications and receiving a common set of input controls. In various implementations, the web browser may comprise built-in widget controls implemented by the mobile device 100.

As shown, the browser UT 105 may display a menu bar 115 comprising a set of icons. The menu bar 115 may be implemented as an application flip tray comprising a page flipping UT such that the user can flip through web applications or widgets very fast in response to a single user event such as single screen touch (e.g., pressing or sliding), button press (e.g., navigation button, a dedicated hard key, a soft key), or interaction with auxiliary controls such as a jog-dial wheel. The user also may select or advance to a particular web application by using any combination of touchscreen events (e.g., touching or pressing on an icon), button events (e.g., mobile device 100 may have dedicated hard or soft key buttons for select, next, and previous), jog-dial events, and screen events (e.g., clicking an icon via a mouse or other random navigation events. In some implementations, the icon tray may auto-hide itself to reserve available screen area. In such cases, the icon tray may only appear momentarily when the user is switching between web applications using the aforementioned events. In one or more embodiments, the menu bar 115 may be implemented as application management framework UI.

As depicted in this exemplary embodiment, the set of icons includes icons for switching between and among active web applications. As shown, the icons may be implemented as a clock icon, a web mail icon, a weather icon, a search icon, a news reader icon, and a stock listing icon. The icons may correspond, for example, to active web applications or widgets such as a clock application, a web mail application, a weather application, a search application, a news reader application, and a stock listing application. It can be appreciated, however, that the arrangement and order of the icons does not necessarily have to correspond to the order of the web applications. In some embodiments, for example, the user may set preferences, drag and drop, move, add, remove, and/or otherwise customize the set of icons displayed by the menu bar 115.

It also can be appreciated the positions and shapes of the components of the menu bar 115 are not limited to the embodiment shown in FIG. 1. The attributes of the menu bar 115 may be easily changed by modifying graphics elements or layout parameters of the underlying web page and are readily customizable by the web page author. For example, while the menu bar 115 is shown as a horizontal bar at the bottom of the web browser UT 105, it also may be placed in a vertical bar along the left side of the web browser UT 105. The menu bar 115 also may be hidden at times. As another example, any number of web application icons may be used, each corresponding to web application, as is practical.

In accordance with various embodiments, the mobile device 100 may provide a mechanism by which web-based advertisements are incorporated into web applications. For example, within the application management framework, web applications may use existing advertising link and scripting methods, yet be viewable on a wide range of devices, including computers and mobile phones.

As shown in the exemplary embodiment of FIG. 1, the web application UT 110 presented by the mobile device 100 comprises a web advertisement such as a banner ad 120. In this embodiment, the user of the mobile device 100 is presented with a web application UT 110 corresponding, for example, to a web application (e.g., news reader application) containing an ad area in a portion of its screen area. The ad area may be filled with an impression-based ad such as banner ad 120. In various implementations, the banner ad 120 may be actionable (e.g., hyperlinked) and can be clicked on or selected via keypad or touch enabled controls of the mobile device 100.

In this exemplary embodiment, when the user interacts with (e.g., clicks) the banner ad 120, the web application may connect to a website affiliated with the web application developer, a merchant website, or another website or server to provide additional services. For example, another UT may be presented within the browser user interface 105 such as the UT of a merchant website associated with the banner ad 120 or other normal website on the Internet. In some cases, the user may be presented with a previously hidden screen, stored within the web application that permits either a more detailed view of the advertising information or an interactive screen where the user can interact with the advertisement.

In various implementations, a particular web advertisement to be displayed by the mobile device 100 may be selected based on caller identifier information. The caller identifier information may be obtained from an incoming call to the mobile device 100 or from an outgoing call from the mobile device 100. Based on the caller identifier information, the mobile device 100 may generate and send an ad request to a web advertising server. The ad request may be sent to the web advertising server immediately or deferred until at a later time. The ad request may be used for querying the web advertising server with the caller identifier information.

In some implementations, the ad request may comprise the caller identifier information. In other implementations, to maintain the anonymity of the customer or advertises, the ad request may comprise a category of business rather than the actual caller identifier to perform the query. In one or more embodiments, a hash of sensitive information may be used to verify identity authenticity without having to disclose actual identity (e.g., certificate signing, etc.)

In response to the ad request, the web advertising server may select a relevant advertisement based on the caller identifier information and may send the relevant web advertisement to the mobile device 100. The mobile device 100 may receive the web advertisement relevant to the caller identifier information and store the web advertisement in a local database on the mobile device.

On the mobile device 100, the web advertisement may be inserted into a web application and displayed to the user. As shown in FIG. 1, for example, the banner ad 120 may be inserted into a web application and displayed in the corresponding web application UT 100. In some embodiments, the web advertisement may be displayed by the mobile device 100 in the telephone user interface software or in a separate software application. In some implementations, the web advertisement may be displayed immediately in a user interface on the mobile device such as in a telephone user interface during a call. The web advertisement also may be stored and displayed at a later time. For instance, web advertisements stored in the local database on the mobile device 100 may be inserted into a web application even when the mobile device 100 is not connected to an active network.

In various implementations, the mobile device 100 may obtain information from caller identifier tags (e.g., caller ID tags) or subsequent queries. The information obtained from the caller identifier tags or subsequent queries need not be used immediately. Instead, this information may be stored or cached by the mobile device 100 for later use at an appropriate time, even when the mobile device 100 is not immediately connected to a network or out of cellular coverage. Information obtained from the caller identifier tags or subsequent queries also may be used directly in a web application on the mobile device 100.

When the user views and/or clicks on the web advertisement (e.g., banner ad 120), the mobile device 100 logs the interaction (e.g., view and/or click) of the user with the web advertisement. For example, a business method may be implemented in which revenue from the advertiser may be used to partially or wholly subsidize the user's ownership or service plan for the mobile device.

In various embodiments, a web application on the mobile device 100 may interact with the server of an advertising provider in online or in offline modes. For example, user/ad interaction may be submitted to the server of an advertising provider immediately (e.g., online mode) or deferred (e.g., offline mode). Advertising content also may be cached (e.g., one or more links deep) so that the content of a clicked ad can be accessed when offline. An authentication sequence may be implemented to ensure legitimacy of ads that are viewed/clicked offline and deferred for later reporting. For example, when a user clicks an ad when the mobile device 100 is offline, the click is logged with a timestamp. An identifier, timestamp, and device certificate are combined in a hash and stored. The hash can later be compared against the device certificate to ensure a match to the timestamp/device. When online, the package is sent to the server of the advertising provider for ad revenue payment processing.

In some implementations, authentication or auditing steps may occur among the mobile device 100, a web application distributer, a web application developer, and an advertising provider to ensure that the advertising transactions are legitimate and that “click fraud” does not occur. For example, parties to a transaction may be required to provide appropriate security credentials to ensure the security and integrity of the transactions among the parties.

In accordance with various embodiments, one or more of the web applications may include a web advertisement and/or may themselves be advertisements. In addition, various revenue sharing models may be implemented in accordance with the described embodiments. In some implementations, revenue generated when the banner ad 120 is clicked may be shared with the web application developer. For example, a web application developer may have several options for generating advertising revenue. One advertising option includes adding a web advertisement to a web application or widget. In some cases, a distributer of the web application may add a web advertisement to a web application during run-time. In other cases, the web application developer may include the web advertisement in the web application or include a web link or script within the web application so that the web application may obtain advertisements from the server of the advertising provider when requested.

Another advertising option is an ad-free implementation where the widgets are sponsored. In this case, the web application developer may pay the distributer of the web application to disable ads. The web application developer then owns the whole screen of the web application and the user experience. The web application may be effectively implemented as one large interactive branded advertisement. The web applications provide value to users while letting marketers get their message out. In some cases, the web application may comprise a direct click-through to the brand's website.

When advertisement displays are generated within the web application UT 110 on the mobile device 100, the web application developer may receive a royalty. For example, the web application developer can receive a royalty for each installation of their application on a device, for use/user interactions of their application on a device, for advertising revenue generated through their application on the device, and/or for the revenue generated by the action occurring subsequent to an ad or widget click-through (e.g., subsequent purchase of goods or services following a click-through to a merchant website). Ad interactions may use cost per thousand (CPM), cost per click (CPC), cost per (CP) application use models, and others. Such CPM, CPC, and CP application use models may be based on screen area reserved for ad interactions.

As described, various embodiments provide the user with an incentive to download and use web applications. In addition to the activities and services provided by the web applications, the user may receive credit for viewing and/or clicking on web advertisements which may be used to partially or wholly subsidize the user's ownership or service plan for the mobile device 100.

The web application developer has a financial incentive to create web applications to share in advertising revenue and a mechanism to distribute authored web applications via a distributer. The web application developer also has a mechanism to obtain advertisements from the advertising provider. Furthermore, the web application developer may earn advertising revenue for transactions by the user even when the mobile device 100 is not online. The advertising provider may earn a profit from its advertisers and has a mechanism to distribute its advertisements via web applications.

The distributer has an incentive to distribute web applications to users by sharing in advertising revenue. Furthermore, the distributer may earn advertising revenue for transactions by the user even when the mobile device 100 is not online. This makes possible a business method of providing free or low-cost web applications to end users where advertising revenue may be shared among web application developers, device makers, service providers, and even end users. This creates a participation incentive for all involved. As described above, the embodiments create a self-sustaining “virtuous cycle” where all participants benefit. It can be appreciated that, in some embodiments, some or all of the roles of the user, the distributer, the web application developer, and the advertising provider may be played by common entities.

Further exemplary embodiments are discussed below in which like reference numerals refer to similar elements as described above. It can be appreciated that any of the features, structures or characteristics described in the context of a particular embodiment are not limited to such embodiment and are not intended to suggest any limitation as to the scope of use or functionality of such embodiment.

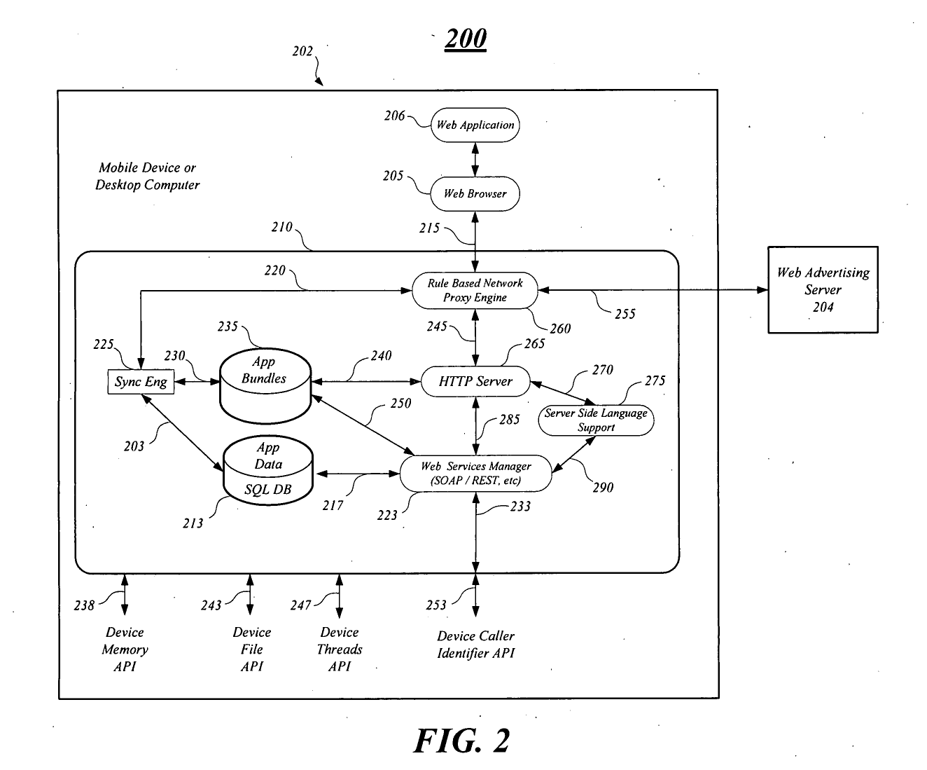

FIG. 2 illustrates an embodiment of a communications system 200 suitable for practicing various embodiments. Although FIG. 2 depicts a limited number of elements for purposes of illustration, it can be appreciated that the communications system 200 may include more or less elements as well as other types of elements in accordance with the described embodiments. Elements of the communications system 200 may comprise physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

As shown, the communications system 200 may comprise a computing device 202 and a web advertising server 204. As shown, the computing device 202 may comprise a web browser 205 and a Web Virtual Machine (WebVM) 210. In general, the WebVM 210 may implement a local web host to provide server functionality on the computing device 202 and to serve local applications to the web browser 205. When implemented as a server on the computing device 202, the WebVM 210 may support and provide access to multiple applications. The WebVM 210 may run server side code such as PHP, Python, PERL or CGI programming environments locally on the computing device 202. The WebVM 210 also may implement web methods programming interfaces and web services extensions via SOAP, XML RPC, REST, and the like for enabling access to local resources of the computing device 202. Accordingly, the computing device 202 may provide server side interfaces to access local resources such as a file system, a phonebook, a media store, a database, a hardware component (e.g., camera, microphone, etc.), a software component, and/or other controlled resource of the computing device 202. Such interfaces also may implement server side code for allowing the user to write to a local resource such as a phonebook, media store, and so forth.

The WebVM 210 may implement security measures such as secure HTTP (https) and/or other login methods to obtain user authentication for preventing unauthorized access and use of the applications and/or other resources. The WebVM 210 may be configured to intermediate between the applications on the computing device 202 and the web browser 205 to broker local services and ensure that only a trusted entity is given access to specific functionality. The WebVM 210 also may implement various web based security models and access restrictions for evaluating function calls from a web browser which request access to local resources of the computing device 202.

The web advertising server 204 may be arranged to store various types of web advertisements. The web advertising server may be further arranged to respond to ad requests and/or queries from the computing device 202 and deliver relevant web advertisements to the computing device 202. In various implementations, the web advertising server 204 may comprise or utilize any suitable computing devices having computing capabilities and/or communications capabilities in accordance with the described embodiments. Exemplary computing devices may include, without limitation, a server, a server array or server farm, a web server, a network server, an Internet server, a distributed computing system, and so forth.

As shown, the web browser 205 may interact with a web application 206. In various implementations, the WebVM 210 of the computing device 202 may be communicatively linked to an application management framework implemented by the web browser 205. For example, although the web application 206 is shown as being separate from the web browser 205, in some embodiments, the web application 206 may comprise one of multiple web applications encapsulated within an application management framework implemented by the web browser 205.

If the computing device 202 is connected to a network, the web application 206 in conjunction with the application management framework and/or the WebVM 210 may request and obtain an advertisement from the web advertising server 204 via the network. Advertisements may be obtained by the WebVM 210 even when the web application 206 is not running.

The advertisement may then be downloaded and inserted into the selected web application 206 regardless of whether the computing device 202 is connected to an active network and regardless of whether the given web application 206 is running or not. For example, if the computing device 202 is not immediately online, the web application 206 in conjunction with the application management framework and/or the WebVM 210 may load a cached or preloaded advertisement from local storage of the computing device 202. The advertisement may then be inserted into the selected web application 206. These cached or preloaded advertisements may be obtained from time to time by the WebVM 210 from the web advertising server 204, regardless of whether a given web application is running or not.

If the computing device 202 is not online whenever a user views or clicks on an advertisement, the transaction is logged for later transmission. From time to time, when the computing device 202 is online, the WebVM 210 may then transmit the relevant transaction information to the web advertising server 204 so that the user may receive credit and/or the web application developer may receive an advertising commission. This may occur regardless of whether the web application 206 that contains the advertisement is running or not.

If the computing device 202 is online when the user clicks on an advertisement, the web application 206 in conjunction with the application management framework and/or the WebVM 210 may transmit the relevant transaction information to the web advertising server 204 so that the user may receive credit and/or the web application developer may receive an advertising commission. In an alternate embodiment, the WebVM 210 may instead defer the transmission of the advertising transaction details until a later time (e.g., to batch transmit many transactions at once).

FIG. 2 depicts one possible implementation of a WebVM 210 configured to run on a computing device 202 such as mobile device (e.g., mobile device 100) or desktop computer. In various embodiments, the Web Virtual Machine (WebVM) 210 may be implemented as described in U.S. patent application Ser. No. 11/612,282 titled “System for Running Web Applications Offline and Providing Access to Native Services,” which was filed on Dec. 18, 2006 and is entirely incorporated by reference.

As shown, the WebVM 210 interacts directly with the web browser 205 via a connection 215, which may be implemented as an http network connection which runs on the computing device 202. Typically this can be invoked by the web browser 205 connecting to a local host IP address (e.g., 127.0.0.1) or other suitable addresses or address and port combinations. Accordingly, different applications may be served by the WebVM 210 simultaneously on the different address port combinations and at different security levels with each application having different permissions levels and access rights to local resources.

The WebVM 210 connects to device services of the computing device 202 through interfaces such as application programming interfaces (APIs) including Device Memory API 238, Device File API 243, Device Threads API 247, and specialized device functions and APIs 253. It is noted that WebVM 210 uses APIs 238, 243, and 247 to connect resources that facilitate internal operation such as memory access, file system, and task/threading and are also used for porting of the WebVM 210 among different classes of devices and operating systems.

The interface 253 may be implemented as one or more meta-interfaces which represent the expandable nature of the WebVM 210. In accordance with various embodiments, the interface 253 may comprise a Device Caller Identifier API. Using SOAP, REST, or other web services bindings, web programs running either in the WebVM 210 or via the web browser 205, such as through Ajax, can access special services to the computing device 202. For example, the computing device 202 may include a phonebook, call log, and access to caller identifier information on the computing device 202 which may be available as a C++ or Java service. By using the interfacing capabilities of the WebVM 210 through the interface 253, it is possible to let web applications run locally on the computing device 202 (e.g., mobile device or desktop computer) without outside server dependencies to be able to access local services and maintain a client-server programming model based on web programming techniques and with web security models intact.

The computing device 200 also may include a phonebook or a digital media store for an on-device camera available as a C++ or Java service. For example web-based phone book application could access the local phonebook on the computing device 200 via the interface 253 and then store associations locally in an a local SQL database 213 to create hybrid functionality. Later the same web application can send or store the phonebook information retrieved via interface 255 to an online web portal on the internet.

In operation, the WebVM 210 operates several portions of an http server stack as depicted by the interaction of the web browser 205 and a network proxy 260 through a path 215. The network proxy 260 may comprise a rule based network proxy engine implementing a software stack which redirects incoming network traffic either to the outside world via an interface 255 or towards an http server 265 via a path 245. For example, a web application 206 authored in XHTML and running a local scripting language (in the web browser 205) such as JavaScript or VBScript may request a new resource such as a new page or an XMLHttpRequest type data call. This request will be brokered from the web browser 205 through the network proxy 260 to the http server 265 for handling.

If the request is for a resource available on the Internet such as web page, a query to the web advertising server 204, or similar addressable asset, the http server 265 can then pull the resource via path 255 and serve it back to the web browser 205 and the web application 206. The http server 265 may also fetch the resource from one of several local objects in the WebVM 210. Such local objects may include a locally mounted file system implemented by the http server 265, a database implemented by a local application bundle manager 235 which is connected to the http server 265 via a path 240, and a the local SQL database 213.

If the request is a data call or a callback function to a server side scripting language (e.g., PHP, Python, Java Enterprise Edition, servlets or Common Gateway Interface Scripts), the http server 265 will hand the request off to a processing engine. In the case of a server side scripting language, the request is handed via a path 270 to a server side language support processing engine 275 which handles the request, provides language specific features, and maintains session management information or server side variables.

If the request is via web description language interface (e.g., SOAP, WSDL, REST, XML remote procedure call, or similar function), then the request can be handed off via a path 285 to a specialized web services manager 223 which functions as previously mentioned to complete the request functionality. For example, the web services manager 223 may access the Device Caller Identifier API 253 via path 233. It is also possible to use the server side language support processing engine 275 to complete the call via a path 290 to the specialized web services manager 223 thereby enabling either Ajax only applications (e.g. applications which only have browser-based code and logic) or server-based code and logic to share SOAP/REST/Web services plug-ins.

The WebVM 210 also can provide access to a local SQL database 213 which is connected to the web services manager 223 via a path 217. The local SQL database 213 provides the ability to store end user data such as preferences, location, or profile information as well as web application data, advertisements, and caller identifier data. The web application 206 running in conjunction with or within the web browser 205 can access the local SQL database 213 via a direct web services software call (e.g., SOAP call) which is issued directly through the web services manager 223. The local SQL database 213 also may be accessed via server side scripts running in the server side language support processing engine 275.

The local SQL database 213 also connects to a data synchronization engine 225 via a path 203. Application resources are stored as application bundles in a database implemented by the application bundle manager 235, which is directly connected via a path 240 to the http server 265. The database implemented by the application bundle manager 235 is also connected to the data synchronization engine 225 via a path 230.

In various implementations, an application bundle 225 can also be fully serviced with or without the HTTP server component by using a message passing interface 250 to interact with the web services manager 223. This allows applications to have direct non-socket based services fulfilled to access local hardware or storage in an efficient manner. Examples of interface 250 may comprise intra-message passing frameworks such as the Linux DBus or other suitable message passing framework. For example, the web services manager 223 may communicate with the application management framework implemented by the web browser 205 over a direct message passing interface. In this model the application environment is dedicated—not just the browser, but browser-like. In other words, a browser rendering engine, such as a webkit renders HTML along with helper libraries for executing JavaScript/ECMAscript but it is not the browser application per se. That is, the user does not realize they are in a browser environment.

The application bundle manager 235 manages entire web application assets. An application may be served from a web archive comprising a collection of the necessary application files for a web application. The web archive file may comprise a bundle or package of the web assets of the web application including index files, HTML files, script files (e.g., JavaScript or server script such as PHP, Python or Perl), graphics (e.g., JPEGs, GIFs), animations, directories, and other web application components. The web archive can be packaged, stored, and compressed using file archiving libraries such as zip, gzip or zlib, or other suitable packing schemes.

When a request is made to a particular file which may be stored as a part of an atomic bundle comprising the application assets, the network proxy 260, the http server 265, and the application bundle manager 235 work in succession to resolve the file just as if it had been hosted on an Internet server. These components also work to resolve same origin policy security enforcement in much the same way that a browser cache does. In other words, xyz.foo.com/mypage.xhtml can be stored locally but accessed in a programmatic way rather than as the browser cache which acts in an automatic (non-programmatically controlled) method. Universal Resource Locators (URLs) which explicitly resolve to local addresses (such as ports running on 127.0.0.1, the http loopback address) resolve and are served to the local web browser 205 via the http interface 210. In some cases, the web browser 205 may not be explicitly aware of the location which actually serves the file.

Additional functionality of the WebVM 210 is provided by using the synchronization engine 225 to update the locally stored applications, such as those stored in the database of the application bundle manager 235 and in the local SQL database 213 via paths 230 and 213, respectively. This allows applications stored as bundles to be atomically stored on the computing device 202 as a single file. The synchronization engine 225 can then manage the storage, updating, upgrading, and subscription status of several such applications. For example a server could store information about a subscription application which the local synchronization engine 225 would enforce. When the subscription expires, the application bundle would be disabled or deleted. This functionality extends the type of application storage once associated with dedicated runtimes (e.g., Java Micro Edition) to web-based applications.

In addition, the synchronization engine 225 can store, synchronize and manage application data stored in the local SQL database 213. In a typical (server-based) application, user data (e.g., shopping cart information on an e-commerce based web store or photographs on a photo sharing website) would be stored on that database of that site. Via the WebVM 210, however, the ability to utilize web-based protocols to store application data locally is now available though web services calls. Moreover, the synchronization engine 225 can then move user data stored in the local SQL database 213 back to a classically running server at an Internet URL. The synchronization engine 225 therefore allows both applications and user data to be stored locally on the computing device 202. Should the computing device 202 be lost or the user acquire a newer, perhaps upgraded device, the applications and the application data for the user can be seamlessly re-provisioned to the new device.

The synchronization engine 225 also can access the external Internet through the network proxy 260 by using a path 220. This allows the synchronization engine 225 to move code assets and user and application data stored in the either the database of the application bundle manager 235 or local SQL database 213 and maintain them in accordance with business rules for subscription or provisioning of the user applications. Since it uses databases to store application bundles and user data, the WebVM 210 can also support different application permissions for different users allowing some to have access to more or different data than others.

The WebVM 210 also may implement various techniques as described in U.S. patent application Ser. No. 11/382,058 titled “Method for Synchronizing Software Application and User Data for Asynchronous Client-Server and Peer to Peer Computer Networks,” which was filed on May 8, 2006 and is entirely incorporated by reference. Accordingly, the WebVM 210 may support the creation of offline web applications and managing associated user data which is created offline that must later be reconciled with one or more central servers without a data collision. This provides knowledge of which version of different pieces of user data are new and which needs to be added to centralized servers. This applies to the actual web application program files so that software applications can be synchronized in addition to user data enabling a transparent online and offline user experience. Data sets can be distributed in manner which allows peer to peer synchronization and filedata distribution. The amount of transactional data required to synchronize data sets across a network can be minimized to increase efficiency of available bandwidth on a computer network.

The WebVM 210 also may implement an offline automated proxy cache as described in U.S. patent application Ser. No. 11/873,305 titled “Offline Automated Proxy Cache for Web Applications,” which was filed on Oct. 16, 2007 and is entirely incorporated by reference. The offline automated proxy cache may support scheduling and automatic repeating of requests for updated data. In various embodiments, scheduling parameters may be used to automatically retrieve updated versions of requested content behalf of a publishing application while the publishing application is offline (e.g., closed, runtime not running, VM not running, etc.). In such embodiments, the WebVM 210 may make repeated Ajax requests on behalf of the publishing application which are repeatedly scheduled to run, even when the publishing application is not running. The publishing parameters may comprise scheduling parameters including, for example, a time interval parameter that defines a time interval for requesting data updates, a history parameter defining a maximum number of versions of the data that may be cached simultaneously, a data expiry parameter specifying when data in the cache expires, a retry parameter defining a number of times to retry a connection, and others.

Repeating/auto-scheduled requests may be terminated by overwrite (e.g., if the publishing application sends an identical request with no scheduling parameters, then scheduling is removed), by explicit request deletion (e.g., if the publishing application sends a parameter to delete the published request via serial number then the auto scheduled request is removed), by application deletion (e.g., if the publishing application is deleted by the user or the operating system, then all autopublish, and proxy requests associated with the application are removed from the system), by programmatic flush (e.g., an API exists on the proxy publisher to suspend a given or all proxy-publish requests), and/or by timeout (e.g., if a given publishing application does not renew the proxy publish request in a given time such as two weeks, then the proxy publisher may allow the repeated proxy request to age out, stop repeating, and be deleted from the queue along with any stored data and rules).

In various embodiments, some or all the above publishing parameters may be wrapped in a namespace determined by the application using the WebVM 210. This namespace wrapping may be performed automatically. For example, if a publishing application such as MySuperWidget.wgt calls the WebVM 210, the stored query and request data will be put in a namespace or table which is prefixed by MySuperWidget. In this way different applications can store requests with the proxy, and the results will be kept separate to avoid naming conflicts (e.g., two different vendors using the same variable name). Reverse URL naming (e.g., com.lampdesk.MySuperWidget) is explicitly encouraged for some implementations. In addition, a public namespace also may be provided for intercommunication messaging.

The WebVM 210 also may implement an application runtime environment as described in U.S. patent application Ser. No. 12/019,362 titled “System and Methods for Providing Granular Security for Locally Running Scripted Environments and Web Applications,” which was filed on Jan. 4, 2008 and is entirely incorporated by reference. The application runtime environment may provide finer granularity and control at the function level rather then forcing an all or nothing approach to control over an application where the application either runs completely unfettered or is completely blocked from running. In particular, the application runtime environment may allow scripted runtime based applications to call local functions in a signed manner with function call level control.

With respect to web archives, the collection of web assets for a web application may be treated as a single file which can be signed and distributed in a secure fashion. A signing file (e.g., manifest file) may be automatically generated when bundling the web archive to provide details as to the APIs (e.g. SOAP calls) an application uses at signing when the application is registered with the certifying authority. When provided with a list of native functions to be used by an application, both the signing authority and the system where the application is eventually installed can compare functions that the application attempts to use against the list of functions which were signed and authorized. This provides an extra layer of security for the target operating system and implementation of system wide security policies to determine whether to allow an application to be installed and whether the functions that an application uses violate such policies.

The decision to execute a function call may be delegated in real-time to the operating system so that overall security is consistent with the blanket security policies of the operating system. By giving responsibility for allowing function calls to the operating system, platform level security control at the API level may be implemented across multiple runtime environments and requiring the runtime environments to only track which application is requesting what service. Accordingly, the operating system may maintain control of security and access for scripted applications and minimize the amount of security authority that must be deferred to the various application runtime environments.

The application runtime environment also may couple the signing process and installation of virtual machine or scripted runtime layer based applications back to core operating system in a unified way. In particular, the operating system may be involved in the accepting of signed scripted or bytecode based applications when granting permission to install an application. In addition, by using IP address and port address combinations, multiple separate web application running on the same local computing device may be tracked and kept separate. Accordingly, different security levels may be enforced among multiple applications running on the same device and application integrity may be persevered even if one of the applications is a “rogue” application.

The WebVM 210 also may implement a proxy publisher as described in U.S. patent application Ser. No. 12/116,697 titled “Automatic Conversion Schema for Cached Web Requests,” which was filed on May 7, 2008, which is entirely incorporated by reference. The proxy publisher may implement an automatic conversion schema which allows data results from a publishing application to be extracted and displayed by a display application other than the publishing application. For example, the proxy publisher may receive a request from a publishing application to retrieve a data result from a data server. The request may include a path to the data server and appended publishing parameters. In accordance with the automatic conversion schema, the publishing parameters may comprise decode parameters associated with the publishing application for allowing a display application other than the publishing application to decode variables of the data result and to transform the decoded variables for display. The proxy publisher may cache the request including the appended publishing parameters and retrieve the data result from the data server. The proxy publisher may locally store the data result along with the cached publishing parameters and may respond to a query from a display application for data associated with the publishing application by providing the cached data result and the publishing parameters to the display application.

In one exemplary embodiment, the publishing application may comprise an XHTML widget written in JavaScript and XHTML. The proxy publisher may receive a request (e.g., Ajax request) from the publishing application to retrieve a data result over the Internet from a remote data server. The request from the publishing application may include a path to the remote data server such a Uniform Resource Locator (URL) and appended publishing parameters.

The proxy publisher may process the request from the publishing application by caching the request including the appended publishing parameters and passing through the path to the remote data server. The remote data server may respond in normal fashion by returning a data result. The proxy publisher may receive the data result from the remote data server and process the data result by locally storing the data result with the cached publishing parameters for the publishing application.

The publishing parameters may comprise decode parameters associated with the publishing application for allowing a display application other than the publishing application to decode variables of the data result and to transform the decoded variables for display. The decode parameters may name the variables which can be extracted to publish a minimized representation of the publishing application. For example, a widget may publish a minimized representation of a weather application by releasing only the day's high temperature or a minimized representation of an e-mail application by releasing only the number of unread messages.

The decode parameters also may comprise data extraction rules and data formatting rules for instructing the display application how to extract web-request data (e.g. weather) from data result (e.g., response text), how to format the data (e.g. put this string+with the extracted web-request data), and how to display the data (e.g., display supplementary information such as a URL or text along with the response text).

Subsequently, the proxy publisher may receive a query from the display application. In some cases, the display application may request data from a specific named request. For example, the display application may request data associated with the publishing application. In other cases, the display application may ask the proxy publisher for a listing of all names for currently stored non-private (published) request data. By default, the proxy publisher may return all the named rules if the display application does not ask for a particular name.

Upon receiving an available name selected by the display application, the proxy publisher may provide a matching result including the locally stored data results and the publishing parameters to the display application. The display application may process the matching result by using the extraction rules to extract and decode the variables and using the formatting rules to display the extracted values in an appropriate manner. In some embodiments, the proxy publisher may reduce the processing required by the display application by extracting the variables from the data result using the data extraction rules and providing the extracted variables to the display application along with the data formatting rules.

In general, when the publishing application is a web-based application, the display application may be implemented as a viewer application or mobile device home screen outside of the web browser which cannot render standard web based content. For example, the display application may comprise a C/C++ active home screen, news aggregator, billboard, or mobile device ticker where only a small amount of information is displayed but that requires transformation of the cached data results to be usable. By using the decode parameters provided by the publishing application, the display application can transform the cached data into a format that it can use. Once the display application has obtained the variables in a usable format, the display application may republish the data in another format.

In accordance with the automatic conversion schema, the publishing parameters may comprise decode parameters for allowing the display application to decode variables of the data result and to transform the decoded variables for display. The decode parameters may comprise a name parameter (e.g., var_name) and a variable name for allowing the publishing application to name the variables extracted. The variable name may be used by outside applications to address a parameter left by the web application. The variable name may not be the name encoded in the offline proxy request, but it is the name (e.g., “Temp_Hi”) referred to by an outside application.

The decode parameters may comprise a data extraction rules parameter (e.g., extraction_rules, var_extract_regex) and instructions for extracting information from the response or data result. The publishing application may cause the proxy publisher to store, with the information request, instructions for extracting information from the response. The extracting instructions may be used by an outside application (e.g., display application) or the proxy publisher to extract (find) the information referred to by the name parameter (e.g., var name) from the stored offline proxy request.

The extracting instructions may be implemented as a regular expression (regex) (e.g., JSON call): get_bytes[23-28] or a “capturing regular expression” in a server side scripting languages such as PERL regex. The extracting instructions also may be implemented via XPath or XQuery. The extracting instructions also may comprise an XSLT transformation. The extracting instructions also may comprise a custom program which is, in itself, the instructions for processing the request. For example, the stored instructions for extracting information from the data result may be implemented as an XHTML page containing JavaScript.

The decode parameters may comprise a data formatting rules parameter (e.g., formatting rules) and instructions for displaying variables from the data result in a format used by an outside application (e.g., the display application). The publishing application may cause the proxy publisher to store, with the information request, a set of optional separate instructions for how to display and format the extracted data. The formatting instructions may comprise a string which is what an extracting application can display in an alert dialog. This parameter can be duplicated with different language parameters. The formatting instructions can be a transforming rule-set which takes the extracted value and displays it in a certain format (e.g. if 2007.04.11 is the date, then it is transformed via a regex to Apr. 11, 2007) such as via XSLT. The extraction instructions are used to extract the data returned by a server located at the URL formed by the calling application (e.g., publishing application), and the formatting instructions detail how the extracted data should appear in a certain application (e.g., display application) outside of the calling application.

The formatting instructions may be implemented by a regular expression (regex) separate from the regex used to extract the data. The formatting instructions also may comprise an XSLT transformation. The formatting instructions also may be implemented as a stored program in its own right. For example, the stored program is itself passed as a parameter which takes the extracted data and displays or formats the extracted data in a way which an outside application other than the calling application can use and process. For example, the stored program may comprise a scripted application such as XHTML+JavaScript. The display and formatting instructions also may be implemented by a custom language created for the purpose of formatting the extracted data. The display and formatting instructions also may be implemented by A C/C++ sprintf( ) capable string function parameter.

The decode parameters may comprise a private parameter (e.g., set_request_private) which may be implemented by a flag set so that the offline proxy request will not be readable by outside applications. The publishing application may deliberately not expose its data by directing the proxy to never honor a request from certain applications to provide security. As such, certain application may be prevented from receiving cached data results and publishing parameters for a given publishing application. Accordingly, the publishing application may make offline requests that are private (not shared) with other applications.

The publishing parameters may comprise event parameters or commands for asking the proxy publisher to perform actions on behalf of the application outside of request handling to allow web applications to behave as normal applications but with a background wakeup task. Whether the optional parameters can be executed is security level and operating system dependent. The event parameters may comprise a wake_upon (condition) parameter or command for requesting the proxy publisher to wake up (launch) an application when a certain offline proxy condition is met (e.g., e-mail received). Whether the application will actually be launched is left to security permissions or the operating system. The proxy publisher may implement an operating system service for sleeping applications to publish services which can be read and passed to other applications. For example, a C/C++ application can use the proxy publisher to post a request which self updates and presents a shared publishable result. In general, any compiled (statically linked) application can use the proxy publisher to wake up when a certain wake up condition is met.

The event parameters may comprise an alert_upon (condition) parameter or command for requesting the proxy publisher to post an alert to the operating system when a condition is met (e.g., publishing application needs attention). This allows a web application to post information via the proxy publisher. The response may be a posted message in a dialog box or a textual or iconic notification on the home screen/idle screen of the device. For example, a scripted widget application running on a cell phone device may provide an e-mail viewing service and may set an event such that when the proxy publisher discovers a new e-mail, an event request is posted to the device idle screen so that the user knows to look at their e-mail. The alert parameters also may comprise an optional alert_msg, parameter and an optional alert_urgency parameter.

The offline capabilities of a publishing application may be restricted in accordance with operating system security policies. For example, the proxy publisher may interact with the operating system security policies and permissions to restrict use of publishing application offline capabilities. In some embodiments, the proxy publisher will, for security purposes, include the application signature ID or referring page for the operating system to determine whether to execute a request in response to a wake up or alter condition.

The WebVM 210 also may be implemented as described in U.S. patent application Ser. No. 12/061,179 titled “System and Methods for Providing Access to a Desktop and Applications of a Mobile Device,” which was filed on Apr. 2, 2008 and is entirely incorporated by reference. Accordingly, one or more web applications hosted on the computing device 202 may be configured to be accessed by a web browser running on a terminal separate from the computing device 202. In various implementations, the UT displayed by the terminal may comprise an enhanced interface as compared to the UT of the computing device 202. For example, an application on a mobile device may be configured to serve up a UT comprising a phone-centric interface to the browser of the mobile device and configured to serve up a UT comprising an enhanced (e.g., larger/better/different) interface when connected to the browser of the terminal. In general, an application may serve a simplified interface to display on the mobile device and an enhanced interface to take advantage of the larger and/or more useful assets (e.g., larger screen, a full-size keyboard, a mouse, memory, browser plugins, hardware, etc.) of the terminal. For instance, an application on a mobile device which uses 4-way navigation and 2 soft keys when in a phone mode may serve an enhanced UT to the terminal that can use navigation hardware such as the full keyboard and mouse and that displays more content in the larger screen of the terminal.

The use of web-based technologies may allow a mobile device to deliver rich data applications such as small widgets or even conventional larger applications. In some cases, for example, a mobile device may be configured to host and run PC applications. In such cases, an enhanced version of the application may be run when accessed by the terminal while a simpler version of the application runs when accessed by the hosting mobile device. The application may be configured to support both environments without requiring modification of the application in the process. As such the application may detect its environment and run differently when used by the mobile device and when used by the terminal.

The WebVM 210 also may be implemented as described in U.S. patent application Ser. No. 12/181,776 titled “Application Management Framework for Web Applications,” which was filed on Jul. 29, 2008 and is entirely incorporated by reference. In various embodiments, the application management framework may interact with a web browser and the WebWM 210. When combined with the WebVM 210, the capabilities of the application management framework may be extended to provide several additional advantages. For example, one or more of the web applications within the application management framework may interact with local web applications or native applications running on a local server within the WebVM 210, all within the computing device 202 itself. This is advantageous during times when the computing device 202 is not connected to a network, or when there is a need to store data from a web application locally on the computing device 202. In various embodiments, resident or nonresident web applications such as widgets may include the ability to publish a notify to a home screen of the computing device via an offline proxy implemented by the WebVM 210.

In some cases, web applications may be inserted directly in the source code for the application management framework. Additionally or alternatively, the WebVM 210 may store one or more web publications to be loaded by the application management framework at startup or upon request by the user. In various embodiments, a list of web applications may be stored in “cookies” on the computing device of the user so that the web applications can be reloaded or configured. In some cases, the list of web applications may be served via server-side logic (e.g., SOAP, REST, JSON, etc.). Some embodiments may use server-side languages (e.g., PHP) to permit building of a web application launcher that may be customized by the user and/or by the web application developer. Certain embodiments also may allow saving of user preferences, configurations, or web application data into a database implemented locally on the device of the user (e.g., via the WebVM 210) or on a network server. In addition, the application management framework 100 may be compatible with “plug-in” technologies such as Adobe PDF, Flash®, VMRL, and others.

Additionally, a web application within the application management framework may utilize the proxy services of the WebVM 210 to access data or services from a different website than the website from which the initiating web application originated. Generally, the “origin policy” used for web applications prevents this behavior such that a script running in a web browser is only able to access or modify data at the website from which the script originated. The application management framework, when combined with the WebVM 210, provides a mechanism to work around this limitation. A suitable security policy may then be implemented within the WebVM 210.

Furthermore, the WebVM 210 can cache frequently needed data so that it is immediately available to a web application, without requiring the user to wait to access the data using the network. This vastly improves the overall user experience, so that it feels to the user that data is always available, even if the connection to the network is low or unavailable.

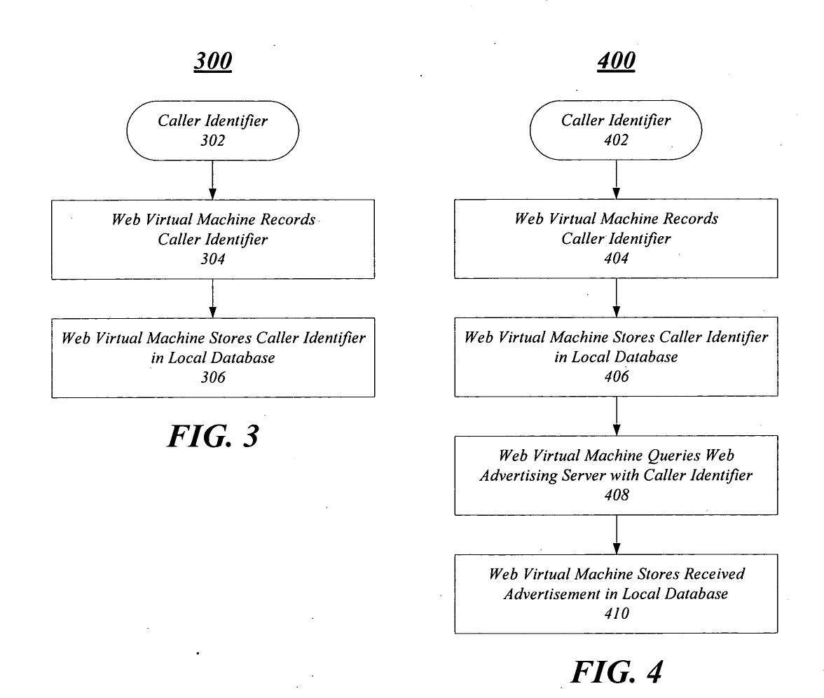

FIG. 3 illustrates one embodiment of a logic flow 300 for storing caller identifier information which may be representative of the operations executed by one or more embodiments described herein. The logic flow 300 may be performed by various systems and/or devices and may be implemented as hardware, software, firmware, and/or any combination thereof, as desired for a given set of design parameters or performance constraints. For example, one or more operations of the logic flow 300 may be implemented by executable programming instructions to be executed by a logic device (e.g., computer, processor).

In this exemplary embodiment, caller identifier information may be stored to an on-device database, such as the local database 213. Upon receiving a caller identifier event (step 302), the computing device 202 (e.g., mobile device 100) and/or WebVM 210 records the caller identifier information (step 304) and stores the caller identifier information in the local database 213 (step 306).

FIG. 4 illustrates one embodiment of a logic flow 400 for storing a web advertisement which may be representative of the operations executed by one or more embodiments described herein. The logic flow 400 may be performed by various systems and/or devices and may be implemented as hardware, software, firmware, and/or any combination thereof, as desired for a given set of design parameters or performance constraints. For example, one or more operations of the logic flow 400 may be implemented by executable programming instructions to be executed by a logic device (e.g., computer, processor).

In this exemplary embodiment, a web advertisement retrieved in response to an ad query based on caller identifier information sent to the web advertising server 204 may be stored to an on-device database such as the local database 213. Upon receiving a caller identifier event (step 402), the computing device 202 (e.g., mobile device 100) and/or WebVM 210 records the caller identifier information (step 404) and stores the caller identifier information in the local database 213 (step 406). The computing device 202 (e.g., mobile device 100) and/or WebVM 210 queries the web advertising server 204 with the caller identifier information (step 408) to obtain a relevant advertisement. The computing device 202 (e.g., mobile device 100) and/or WebVM 210 stores the received web advertisement in the local database 213 (step 410).

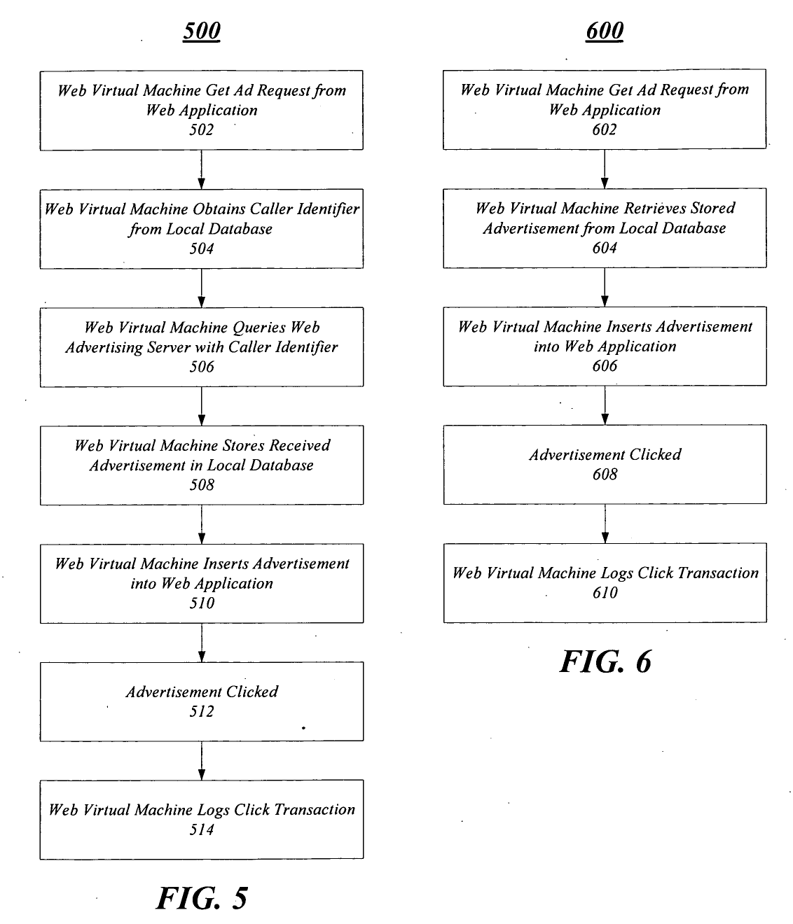

FIG. 5 illustrates one embodiment of a logic flow 500 for inserting a web advertisement into a web application which may be representative of the operations executed by one or more embodiments described herein. The logic flow 500 may be performed by various systems and/or devices and may be implemented as hardware, software, firmware, and/or any combination thereof, as desired for a given set of design parameters or performance constraints. For example, one or more operations of the logic flow 500 may be implemented by executable programming instructions to be executed by a logic device (e.g., computer, processor).

In this exemplary embodiment, a caller identifier-triggered web advertisement may be inserted in a web application 206 when the caller identifier information has been stored in the local database 213. The caller identifier information may be stored in accordance with logic flow 300, for example.

The computing device 202 (e.g., mobile device 100) and/or WebVM 210 receives a request for an advertisement insertion from the web application 206 (step 502). The computing device 202 (e.g., mobile device 100) and/or WebVM 210 obtains stored caller identifier information from the local database 213 (step 504). The computing device 202 (e.g., mobile device 100) and/or WebVM 210 queries a web advertising server 204 with the caller identifier information (step 506) to obtain a relevant advertisement. The computing device 202 (e.g., mobile device 100) and/or WebVM 210 stores the received advertisement in the local database 213 (step 508). The computing device 202 (e.g., mobile device 100) and/or WebVM 210 inserts the received advertisement into the web application 206 (step 510).

Once an advertisement is inserted into the web application, a user may click on the advertisement (step 512). In one embodiment, the computing device 202 (e.g., mobile device 100) and/or WebVM 210 may log the click transaction (step 514) for later transmission to the web advertising service provider associated with the web advertising server 204 so that a credit may be received.

In one or more embodiments, the web application 206, web browser 205, and/or the WebVM 210 may take action as a result of the click on the advertisement to provide the user with additional information or services related to the advertisement. In various implementations, the operation of the logic flow 500 does not require that the computing device 202 (e.g., mobile device 100) be actively connected to a network at the time the ad request is made from the web application 206 or any of the other steps of logic flow 500. That is, advertisements based on caller-id queries may be inserted into the web application 206 running on the computing device 202 (e.g., mobile device 100) using the same procedure regardless of whether the device is “online” or “offline.”

FIG. 6 illustrates an embodiment of a logic flow 600 for inserting a web advertisement into a web application which may be representative of the operations executed by one or more embodiments described herein. The logic flow 600 may be performed by various systems and/or devices and may be implemented as hardware, software, firmware, and/or any combination thereof, as desired for a given set of design parameters or performance constraints. For example, one or more operations of the logic flow 600 may be implemented by executable programming instructions to be executed by a logic device (e.g., computer, processor).

In this exemplary embodiment, caller identifier-triggered web advertisement may be inserted in a web application 206 when the web advertisement has been stored in the local database 213. The web advertisement may be stored in accordance with logic flow 400, for example.

The computing device 202 (e.g., mobile device 100) and/or WebVM 210 receives a request for an advertisement insertion from the web application 206 (step 602). The computing device 202 (e.g., mobile device 100) and/or WebVM 210 obtains a stored advertisement (e.g., from an earlier query to the web advertising server 204, or from a set of preloaded advertisements) from the local database 213 (step 604). The computing device 202 (e.g., mobile device 100) and/or WebVM 210 WebVM inserts the stored advertisement into the web application 206 (step 606).

Once an advertisement is inserted into the web application, a user may click on the advertisement (step 608). In one embodiment, the computing device 202 (e.g., mobile device 100) and/or WebVM 210 may log the click transaction (step 610) for later transmission to the web advertising service provider associated with the web advertising server 204 so that a credit may be received.

In one or more embodiments, the web application 206, web browser 205, and/or the WebVM 210 may take action as a result of the click on the advertisement to provide the user with additional information or services related to the advertisement. In various implementations, the operation of the logic flow 600 does not require that the computing device 202 (e.g., mobile device 100) be actively connected to a network at the time the ad request is made from the web application 206 or any of the other steps of logic flow 500. That is, advertisements based on caller-id queries may be inserted into the web application 206 running on the computing device 202 (e.g., mobile device 100) using the same procedure regardless of whether the device is “online” or “offline.”

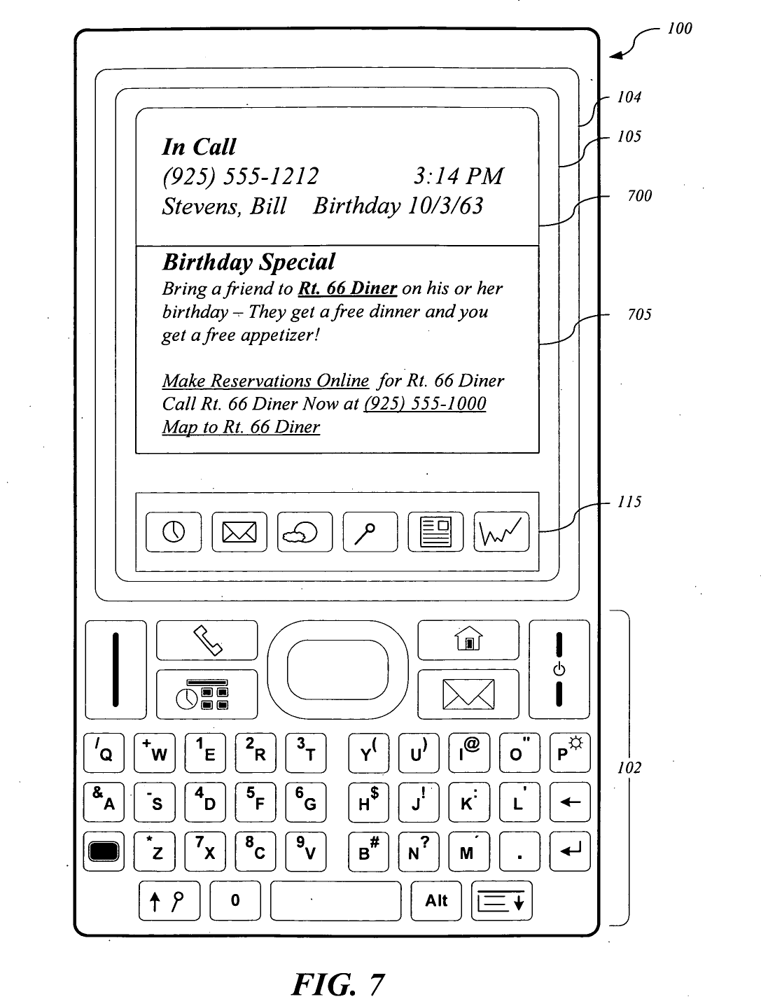

FIG. 7 illustrates one embodiment of a mobile device 100 suitable for implementing various embodiments. As shown, the mobile device 100 may present a web browser UT 105 displaying a menu bar 115 and a telephone UT 700. In this embodiment, the user of the mobile device 100 is presented with a web advertisement 705 which has been inserted into the telephone UT 700 while a call is in progress. In this case, the advertisement 705 has been selected based on the upcoming birthday of the other call participant and the knowledge of the geographic locale of the telephone call area code. By combining the caller identifier information within a web application, the telephone UT 700 displays a web advertisement 705 that may link directly the advertiser's web site (e.g., hyperlink), include a hyperlink for a map, a hyperlink to make an online reservation, and a telephone link to dial the telephone phone number directly from the mobile device 100. All of this functionality may be available without requiring the user quit the telephone application and start a separate web browser or other software application, thereby vastly speeding user interaction.

It can be appreciated that many advertising variations are possible. For example, the web application may provide additional services where billing may be accomplished via a stored or manually entered credit card, billing may be accomplished by direct billing to the user's mobile billing/carrier account, optional services may be tied to the phone number received or called (e.g. it's Sam's birthday—would you like to send a gift?), the user may buy something from a web store/catalog while on the call or at some later time, and so forth.

In some implementations, the telephone number of the other call participant may be queried in a database to determine if the number is on a “watch list” for security purposes or based on the wishes of the user. An appropriate message may then be generated and displayed in the web application, when, for example, a caller is known to be from a fundraising organization. The telephone number of the other call participant may be queried against an advertising database to identify offers for competitors' products. The telephone number of the other call participant may be used to initiate other forms of communication during a call or at some later time. For example, a portion of the web application screen may become an instant messaging session with the other call participant so that text, pictures or files may be exchanged directly between the participants.

It also can be appreciated that a call may include more than two participants. For example, a web application UT may be divided to show all or some of the call participants' information and may permit transfer of text, pictures or files among the participants. Additionally, all of the participants may see the same display in their respective web application user interfaces, or they may see different displays with potentially different web advertisements inserted.

As described, various embodiments make it possible to generate precision-targeted advertisements within web applications on mobile devices based on a caller identifier queries. These advertisements may be highly correlated with the device user's interests and thus very valuable. Additionally, the web applications, advertisements, and content/services associated with a web advertisement may be available regardless of whether the device running the web application is online or offline.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. It also can be appreciated that while a logic flow may illustrate a certain sequence of steps, other sequences of steps may also be performed according to alternative embodiments. Moreover, some individual steps of a logic flow may include multiple sub-steps that may be performed in various sequences as appropriate to the individual step. Furthermore, additional steps may be added or some steps may be removed depending on the particular implementation.

In addition, the logic flow may be implemented by a hardware element, a software element executed by a computer, a firmware element embedded in hardware, or any combination thereof. In various embodiments, the logic flow may comprise, or be implemented as, executable computer program instructions. The executable computer program instructions may be implemented by software, firmware, a module, an application, a program, a widget, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language in accordance with the described embodiments.

In various embodiments, a logic flow may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computing device comprising:
a web application implemented by a web browser; and
a web virtual machine comprising a local web server host on the computing device to obtain caller identifier information for a telephone call, generate an ad query based on the caller identifier information, send the ad query to a web advertising server, receive a web advertisement from the web advertising server, and insert the web advertisement into the web application; and
a display to present the web advertisement in a user interface.

2. The computing device of claim 1, wherein the web virtual machine comprises a device caller identifier interface for accessing the caller identifier information.

3. The computing device of claim 1, further comprising a local database for storing the caller identifier information.

4. The computing device of claim 1, further comprising a local database for storing web advertisements.

5. The computing device of claim 1, the web virtual machine to send the ad query when the web application is not running.

6. The computing device of claim 1, the web virtual machine to receive the web advertisement when the web application is not running.

7. The computing device of claim 1, the web application to display the web advertisement when the computing device is not connected to an active network.

8. The computing device of claim 1, further comprising an application management framework communicatively linked to the web virtual machine, the application management framework implemented within the web browser and encapsulating multiple web applications.

9. The computing device of claim 8, wherein the web virtual machine comprises a web services manager in communication with the application management framework over a direct message passing interface.

10. A computer-implemented method for a computing device comprising:
obtaining caller identifier information for a telephone call;
generating an ad query based on the caller identifier information;
sending the ad query to a web advertising server;
receiving a web advertisement from the web advertising server;
inserting the web advertisement into a web application; and
displaying the web advertisement in an a user interface.

11. The method of claim 10, wherein the telephone call comprises an incoming telephone call.

12. The method of claim 10, wherein the telephone call comprises an outgoing telephone call.

13. The method of claim 10, further comprising storing the caller identifier information in a local database.

14. The method of claim 10, further comprising storing the web advertisement in a local database.

15. The method of claim 10, wherein the ad query is sent and the web advertisement is received when the web application is not running.

16. The method of claim 10, wherein the web advertisement is displayed when the computing device is not connected to an active network.

17. The method of claim 10, wherein the web advertisement is displayed while the telephone call is in progress.

18. The method of claim 10, further comprising logging advertising impressions generated by the web application.

19. The method of claim 10, further comprising receiving credit for advertising impressions generated by the web application.

20. A computer-readable storage medium comprising executable computer program instructions that when executed cause a computing system to:
obtain caller identifier information for a telephone call;
generate an ad query based on the caller identifier information;
send the ad query to a web advertising server;
receive a web advertisement from the web advertising server;
insert the web advertisement into a web application; and
display the web advertisement in an a user interface.
